(19) United States
(12) Patent Application Publication
(10) Pub. No.: US 2006/0034038 A1
(43) Pub. Date: Feb. 16, 2006

(54) Including additional keys for mobile computers

(76) Inventor: Chunhong Hou, Savage, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/916,347

(22) Filed: Aug. 11, 2004

(51) Int. Cl. G06F 1/16

(52) U.S. Cl. 361/680

(57) ABSTRACT

A panel generally designed for a user of a portable computing device to rest his wrists upon when using the portable computing device's integrated keyboard slides to reveal recessed keys contained inside the housing of the portable computing device. Upon opening, the panel will lock and thereby engage the recessed keys. In an alternate embodiment of the invention, the recessed keys extend above the case of the portable computing device when engaged. In an alternate embodiment of the invention, the panel rotates on a hinge one hundred eighty degrees.

### BACKGROUND OF THE INVENTION

A. Field of the Invention

This invention relates to portable computers with integrated keyboards. More specifically, the present invention relates to a moveable panel of the housing of the portable computer that when moved reveals additional useable keys.

B. Background of the Invention

A typical portable computer with an integrated keyboard, commonly referred to as a laptop or notebook, consists of a two-part hinged housing that folds together like a book. See FIG. 1. When in the open position, the upper internal face 110 of the hinged housing consists of a monitor panel 120, and the lower internal face 130 of the hinged housing consists of a keyboard panel 140 located toward the hinge 150 of the housing, a smooth section 160 of the lower internal face of the hinged housing designed for a user to rest his wrists while typing, and in some computers a separate center area used to interact with the computer 170. Notable is the inherent limitation of a portable computer—the intent and goal to minimize weight and size while not sacrificing machine functionality.

Manufacturers and designers have attempted to balance the inherent limitations with machine functionality by producing a common design as depicted in FIG. 2a, featuring an integrated standard typewriter keyboard 210 with some additional function keys 220. Noticeably different from a keyboard generally used on a non-portable computer, as depicted in FIG. 2b is the lack of additional keys 230 to the right of the standard key board, primarily navigation keys 240 and a “10-key” numerical key panel 250. Because the portable computer keyboard layout lacks the number-key panel of its non-portable computer keyboard brethren, the usefulness of a portable computer is minimized in situations in which a user must enter large amounts of numerical data, a task simplified when entered through a “10-key” numerical key panel.

Manufacturers and designers have introduced both design and after market solutions to simplify data entry through a numerical key panel or alternate arrangement. For example, many current portable computers contain a function by which, upon pressing a function key, other keys that are part of the standard keyboard are engaged to act as keys on the numerical key panel, as depicted in FIG. 3a. This alternate function for such keys is of limited usefulness, however, because the keys on a standard keyboard are arranged in an offset fashion, complicating data entry. The limitation is apparent when the arrangement of the designated numerical keys on the standard keyboard, FIG. 3a, are compared to the arrangement of the numerical keys on the numerical key panel, depicted in FIG. 3b, which are arranged on a grid and thereby promoting efficient data entry.

After-market manufacturers have also produced add-on numerical key panels. FIG. 4 depicts one such product. In FIG. 4, the product is a stand-alone device. The product connects to the computer via a separate cable which is not incorporated into the internal electric circuits of the portable computing device. The noticeable limitation of this after market product is it reduces the computer's overall portability and convenience, because it requires the user to carry an additional device that must be attached to the portable computer when in use.

As observed, there is a deficiency in the art whereby the keyboard of a portable computer lacks keys useful to a user of a non-portable computer keyboard. What is needed is to integrate the keys of a numerical keypad into an existing portable computer housing, such that the portable computers portability is not compromised with the addition of such keys.

### BRIEF SUMMARY OF THE INVENTION

In one embodiment of the invention, a panel located in the area in which a portable computer user rests his wrists while typing slides open to reveal recessed keys, potentially arranged in the format of a numerical “10-key” keypad. When open, the panel locks into place, which may activate the keys for use. Additionally, when the panel opens, the panel may additionally function as a wrist rest for the user using the additional keys.

In an alternate embodiment of the invention, the panel located in the area in which a portable computer user rests his wrists while typing rotates open on a hinge, such that when opened the internal face contains keys potentially arranged in the format of a numerical “10-key” keypad. When open, the panel locks into place, which may activate the keys for use.

### BRIEF DESCRIPTION OF THE DRAWINGS

FIG. 1 shows the general design of a portable computer.

FIG. 2a shows the general layout of the integrated keyboard of a portable computer.

FIG. 2b shows the general layout of a non-integrated keyboard commonly used on a portable or non-portable computer.

FIG. 3a shows the numerical keypad arrangement imposed on to the integrated keyboard of a portable computer.

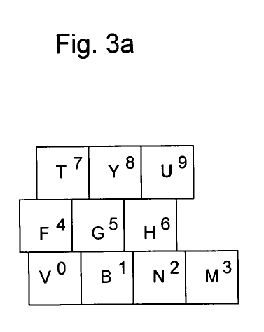

FIG. 3b shows the numeric keypad arrangement of a “10-key” keypad arrangement.

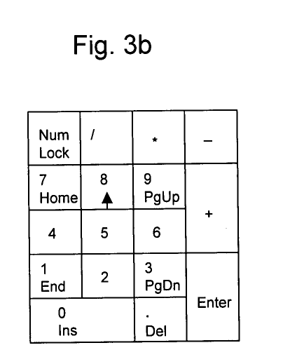

FIG. 4 shows an aftermarket devices designed to provide numeric keypad functionality.

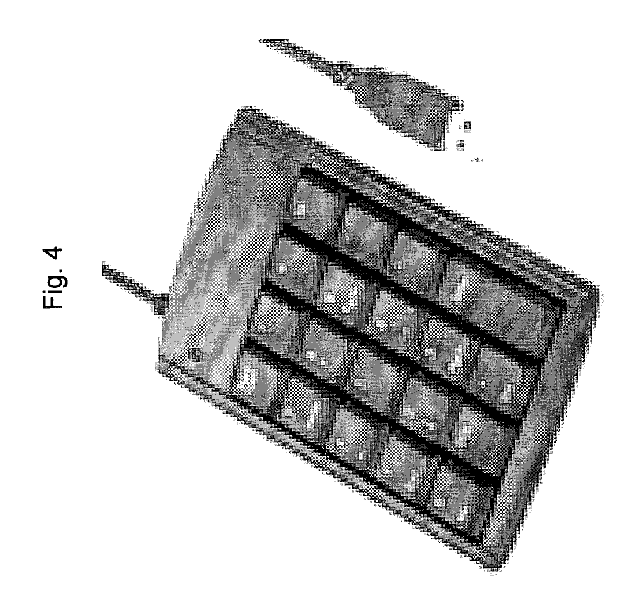

FIG. 5 shows a preferred embodiment of the invention wherein the sliding panel is closed.

FIG. 6 shows a preferred embodiment of the invention wherein the sliding panel is open.

FIG. 7a shows an alternate embodiment of the invention wherein the sliding panel edge is not flush with the edge of the housing and is in the closed position.

FIG. 7b shows an alternate embodiment of the invention wherein the sliding panel edge is not flush with the edge of the housing and is in the open position.

FIG. 8 shows an alternate embodiment of the invention in which the panel opens by rotating about a fixed point.

FIG. 9 shows an alternate embodiment of the invention in which the panel opens by rotating about a fixed point and is in the open position.

FIG. 10 shows an alternate embodiment of the invention in which the panel slides to the parallel to the keyboard panel.

### DETAILED DESCRIPTION OF THE INVENTION

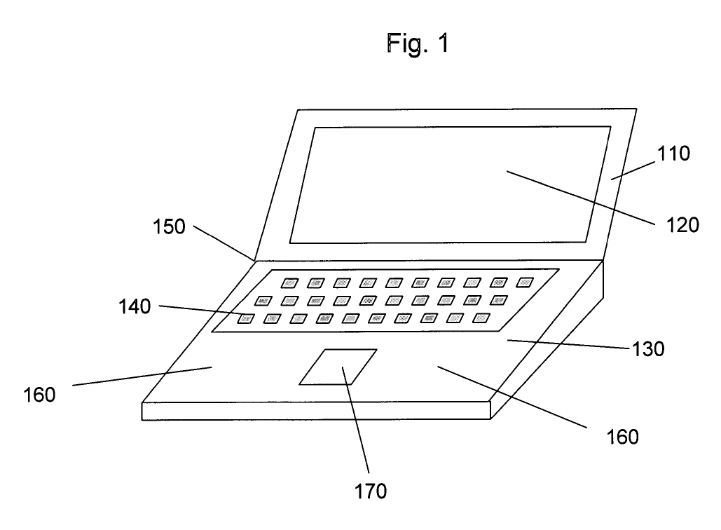

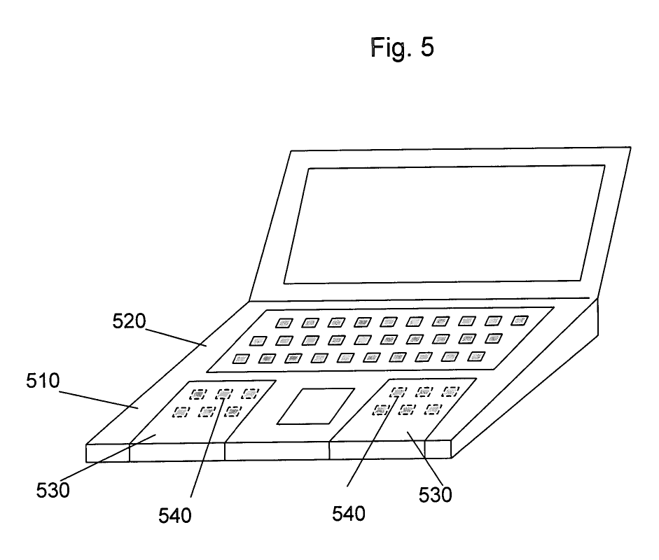

The present invention provides a user of a portable computing device additional keys not generally included in the keyboard integrated within the housing of a portable computing device. FIG. 1 is a depiction of the general design of a portable computing device. This invention incorporates additional keys into the case of the portable computing device that may be accessed by the user at his convenience, but would otherwise not adversely affect the portability of the device. See FIG. 5.

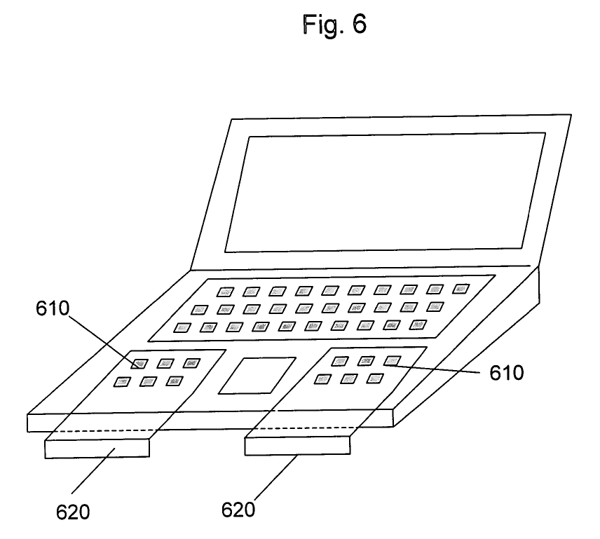

A preferred embodiment of the invention is depicted in FIG. 5. Within the wrist rest area 510 of the lower internal face 520 of the hinged housing, there is a panel or cover 530 that slides toward the user. Beneath the slideable panel, depicted in phantom lines, are additional keys 540 recessed inside the housing of the portable computing device. When the additional keys are required for use, the user slides open the panel to expose the recessed keys 540, and 610 as depicted in FIG. 6. When opened, the panel will lock into the open position. Conversely, when closed the panel will remain securely shut.

In some embodiments of the invention the edge of the housing that is connected to the slideable panel acts as a self-supporting element 620 when the slideable panel or cover is locked in the open position.

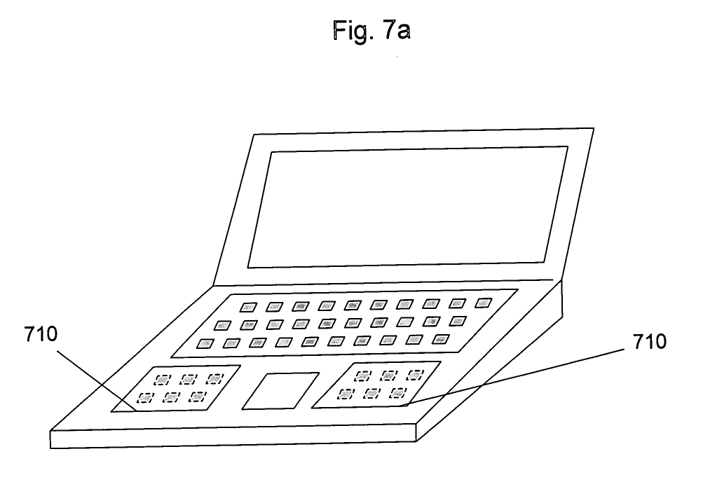

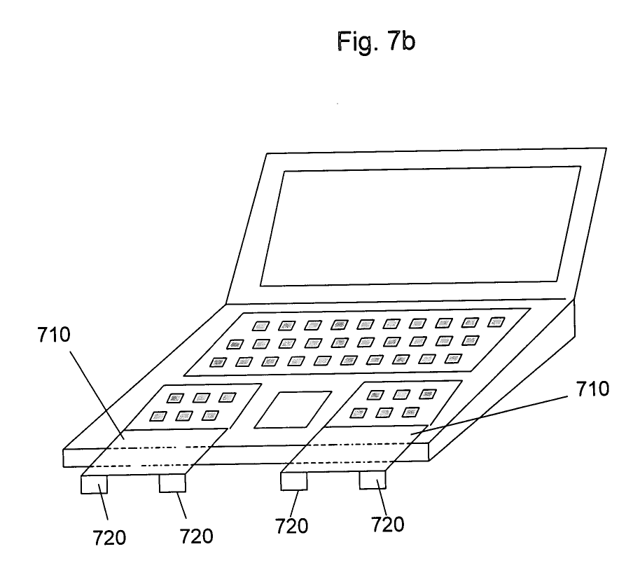

Alternatively, in some embodiments of the invention the edge of the panel is not flush 710 with the edge of the housing when closed, as depicted in FIG. 7a. In such an embodiment, when the panel is secured in the open position depicted in FIG. 7b, a mechanism extends a self-supporting element 720 so the panel may function as a wrist rest. When the panel is moved to the closed position, the self-supporting elements retract or fold in same fashion so the panel is flush with the remainder of the housing.

In some embodiments of the invention, when the slideable panel is opened, a mechanism operates to raise the typing surface of the keys above the edge of the case.

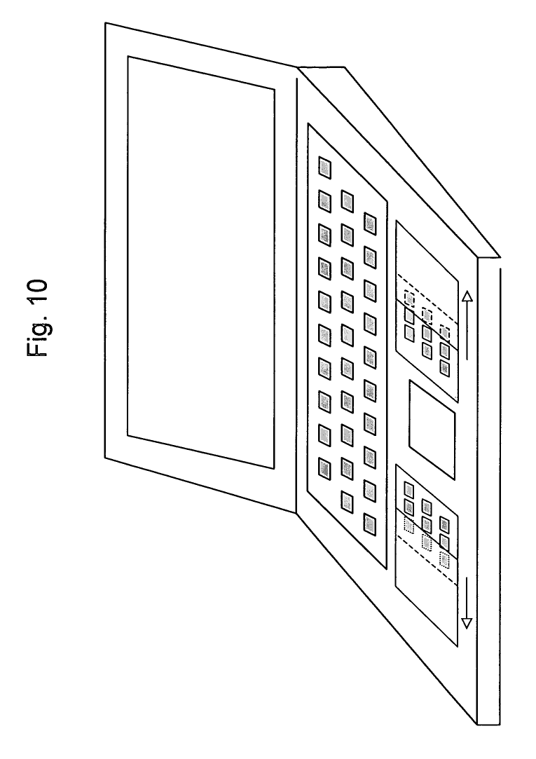

In another embodiment of the invention, the moveable panel may slide parallel to the integrated keyboard. See FIG. 10.

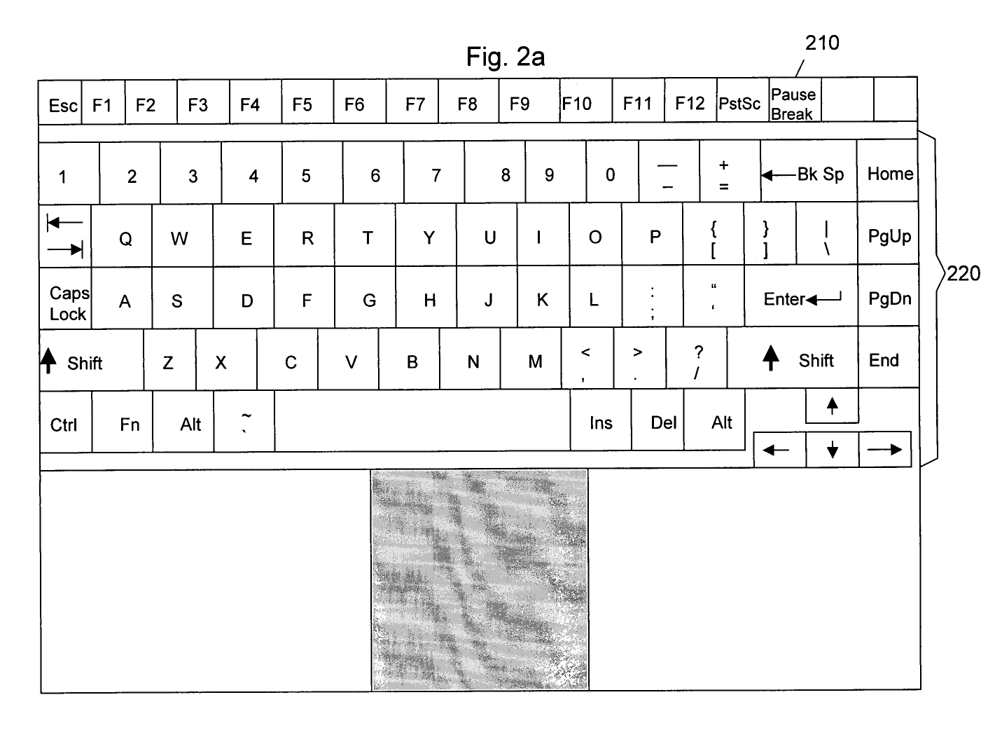

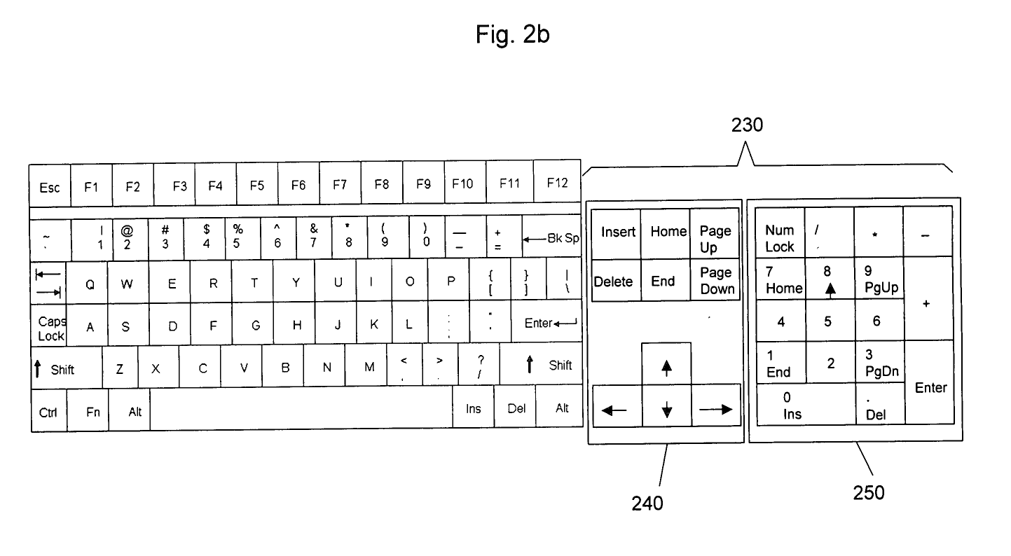

In some embodiments of the invention, the additional keys are arranged in a ten-key format. In another embodiment of the invention, the additional keys are arranged as the “arrow” keys on a standard non-mobile keyboard. See FIG. 2b, reference 240. One skilled in the art will recognize that additional keys other than those found on a numerical keypad may be recessed in the housing of the portable computing device.

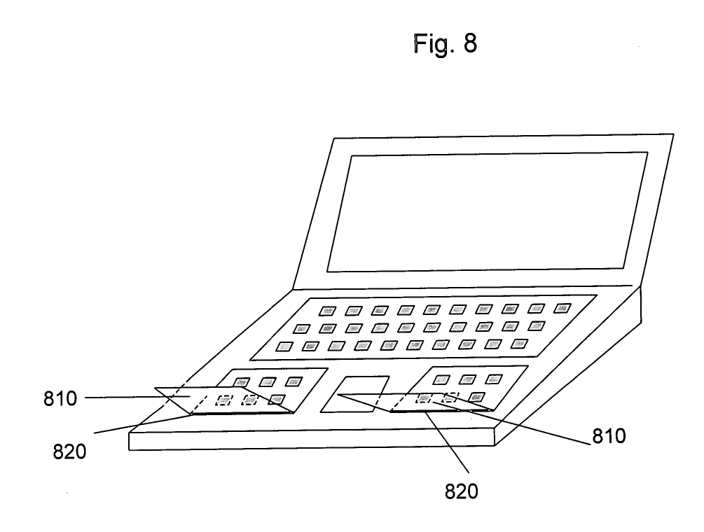

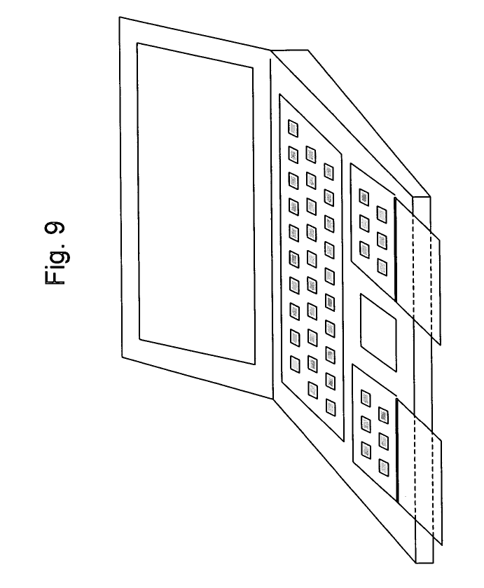

In another alternate embodiment of the invention is depicted in FIG. 8. Again, there is a moveable panel 810 that opens on a hinge 820 that rotates on its axis one hundred eighty degrees. Upon the panel's rotation of one hundred eighty degrees to the open position, depicted in FIG. 9, the panel may lock in the open position. Alternatively, when the panel may also exist in the closed position, whereby it will stay securely shut.

In some embodiments of the invention, when the panel, which either slides or rotates about an axis, is secured in the open position, the keys are activated for use.

Furthermore, one skilled in the art will recognize that described above are some embodiments of this invention, and that other embodiments may exist, with different key arrangements, with different types of covering panels, with different configurations on how to move the cover panel to reveal the keys, etc. Such variations are within the scope and spirit of the present invention.

The invention claimed is:

1. A housing for a portable computing device, comprising:
a plurality of typing keys recessed within the dimensions of the housing not accessible during normal use of the portable computing device;
a slideably attached panel to the housing moveable between an open position and a closed position;
a means that secures the slideably attached panel when the panel is moved to the closed position, thereby covering the plurality of typing keys; and
a means that secures the slideably attached panel when the panel is moved to the open position, thereby exposing the plurality of typing keys.

2. The invention of claim 1 further comprising a mechanism that activates the plurality of typing keys when the slideably attached panel is secured in the open position.

3. The invention of claim 1 further comprising a mechanism that raises the plurality of typing keys, such that the typing surface of the plurality of typing keys is level with the integrated keyboard of the housing of the portable computing device.

4. The invention of claim 1 further comprising a supporting element that secures the slideably attached panel that permits the slideably attached panel to be used as a wrist rest.

5. The invention of claim 4 further comprising a mechanism that retracts the supporting element when the panel is moved to the closed position.

6. A housing of a portable computing device, comprising:
a moveable panel moveable between an open position and a closed position by a means permitting the moveable panel to rotate along a one hundred eighty degree arc;
a plurality of typing keys attached to a side of the moveable panel that is not exposed when the moveable panel is in the closed position;
a means that secures the moveable panel when the panel is moved to the closed position;
a means that secures the moveable panel when the panel is moved to the open position, thereby exposing the plurality of typing keys.

7. The invention of claim 6 further comprising a mechanism that activates the plurality of typing keys when the moveable panel is secured in the open position.

8. A housing for a portable computing device, comprising:
a plurality of typing keys recessed within the dimensions of the housing not accessible during normal use of the portable computing device;
a slideably attached panel to the housing moveable between an open position and a closed position;
wherein the plurality of typing keys are exposed for use when the slideably attached panel is in the open position.
